(19) United States
(12) Patent Application Publication
(10) Pub. No.: US 2015/0236809 A1
(43) Pub. Date: Aug. 20, 2015

(54) Multi-Wavelength Laser Apparatus And Methods

(71) Applicant: Alcatel-Lucent USA Inc., Murray Hill, NJ (US)

(72) Inventor: Po Dong, Morganville, NJ (US)

(73) Assignee: Alcatel-Lucent USA Inc., Murray Hill, NJ (US)

(21) Appl. No.: 14/182,079

(22) Filed: Feb. 17, 2014

(51) Int. Cl. H04J 14/02; H04B 10/61; H04B 10/50

(52) U.S. Cl. CPC H04J 14/02; H04B 10/503; H04B 10/61

(57) ABSTRACT

An apparatus includes a laser that includes a plurality of optical cavities, separate optical gain media for each of the cavities, an optical demultiplexer, and a periodic optical filter. The optical demultiplexer demultiplexes a common portion of the optical cavities into separate portions. The periodic optical filter is inserted into the common portion of the optical cavities.

### FIELD OF INVENTION

This invention generally relates to apparatus and methods for generating laser emission at multiple wavelengths.

### BACKGROUND

This section introduces aspects that may be helpful to facilitating a better understanding of the inventions. Accordingly, the statements of this section are to be read in this light and are not to be understood as admissions about what is in the prior art or what is not in the prior art.

Dense Wavelength Division Multiplexing (DWDM) transmission systems typically rely on lasers precisely tuned to emit at one or more wavelengths complying with a regular grid, e.g., a regular optical frequency grid of the International Telecommunication Union (ITU). In some DWDM systems, carriers of each wavelength are emitted by independent lasers. Each Such laser may be tunable to a desired wavelength. Each such laser may be stabilizable in wavelength and power. Wavelength stabilizable lasers are particularly desirable in optical transmitters and coherent optical receivers for optical communication systems. Such tunable and stabilizable lasers are often expensive and/or cumbersome.

### SUMMARY OF EXAMPLE EMBODIMENTS

Various embodiments provide for multi-wavelength lasers that include a single mechanism for providing wavelength tuning and stabilization.

In one embodiment, an apparatus includes a multi-wavelength laser comprising a plurality of laser optical cavities. Each laser optical cavity includes a corresponding optical amplifier, a periodic optical filter being a common segment of the laser optical cavities and an optical wavelength demultiplexer including an optical input and a plurality of optical outputs. Each of the laser optical cavities includes an optical path segment between a corresponding optical output of the optical wavelength demultiplexer and the optical input of the optical wavelength demultiplexer.

In some embodiments of the above apparatus, the pass bands of the optical wavelength demultiplexer are wider than the pass bands of the periodic optical filter.

In some embodiments of any of the above apparatus, the periodic optical filter has a free spectral range approximately matching the frequency spacing of an ITU grid.

In some embodiments of any of the above apparatus, the periodic optical filter may further include a tunable optical phase shifter and a controller enabling frequency-shifting of the pass bands of the optical filter as a group.

In some embodiments of any of the above apparatus, the optical wavelength demultiplexer may include a plurality of optical resonators, an input optical waveguide optically coupled to the optical resonators, and a plurality of output optical waveguides each optically coupled to a corresponding one of the optical resonators.

In some embodiments, any of the above apparatus may further include an optical data transmitter and/or a coherent optical data receiver. The optical data transmitter may include the laser and an external optical data modulator. The external optical modulator is configured to modulate light emitted by the laser. The coherent optical data receiver may include the laser and may be configured to determine a digital data stream carried by a phase-modulated optical carrier, in part, by optically mixing light of the phase-modulated optical carrier with light emitted by the laser.

In second embodiments, a method of generating a laser output of multiple wavelengths includes producing laser light in a sequence of separate frequency bands by pumping a plurality of spatially separate optical gain media to generate stimulated emission of light therefrom in laser cavities. The producing includes multiplexing the stimulated emission light into a combined light beam, and filtering the combined beam by a periodic optical filter located in a region common to the laser cavities.

In some of the above embodiments, the method may further include mixing light emitted by the laser with a received modulated optical carrier to perform coherent detection of the phase-modulated optical carrier in a coherent optical receiver.

In some of the above embodiments, the method may further include modulating light emitted by the laser to produce modulated optical carriers in an optical transmitter.

### BRIEF DESCRIPTION OF THE FIGURES

FIG. 1 is a block diagram schematically illustrating a first embodiment of a multi-wavelength laser apparatus.

FIG. 2 illustrates a specific example of the first embodiment of a multi-wavelength laser.

FIG. 3 illustrates the optical transmission spectra of various optical components of the first embodiment of a multi-wavelength laser.

FIG. 4 is a block diagram of an optical data transmitter that includes a multi-wavelength laser of FIG. 1.

FIG. 5(a) is another block diagram of an optical data transmitter that includes a multi-wavelength laser of FIG. 1.

FIG. 5(b) illustrates a specific example of the optical modulator of FIG. 5(a).

FIG. 6 is a block diagram of a coherent optical receiver that includes a multi-wavelength laser of FIG. 1.

FIG. 7 illustrates a method of producing multi-wavelength laser outputs.

### DETAILED DESCRIPTION

Throughout various embodiments in this disclosure, some optical components have optical band passes or optical transmittance peaks that are regularly spaced in frequency. For such an optical component, the approximate frequency spacing between neighboring ones of said optical band passes or optical transmittance peaks will be referred to herein as the free spectral range (FSR) of the optical component. If the optical band passes or optical transmittance peaks of an optical component are regularly spaced over a reasonably broad frequency range, e.g., three or more neighboring ones of the optical band passes or optical transmittance peaks, the optical component will be referred to as having a FSR even if strengths of the optical band passes or optical transmittance peaks vary with frequency. Some optical components, having an FSR, have optical band passes or optical transmittance peaks whose strengths vary strongly and/or rapidly with frequency, and other optical components, having an FSR, have optical band passes or optical transmittance peaks whose strengths vary only little and/or slowly with frequency over large frequency ranges.

It is understood by those skilled in the art that the term “optically coupled” and its derivations, as used throughout this disclosure, refer to a state in which two optical elements are connected by a light path. Thus, an optical coupling may be direct or indirect. For example, a first optical component is optically couple to a second optical element, albeit indirectly, even when there are additional optical components between the first and the second optical elements. An optical coupling may occur via free space, waveguide(s), and/or evanescence.

It is further understood by those skilled in the art that the term “beam” or “optical beam” broadly refers to light traveling in any optical path. Thus, the term “beam” is not confined to free space. A beam can be light traveling in, for example, free space, a planar waveguide, or an optical fiber.

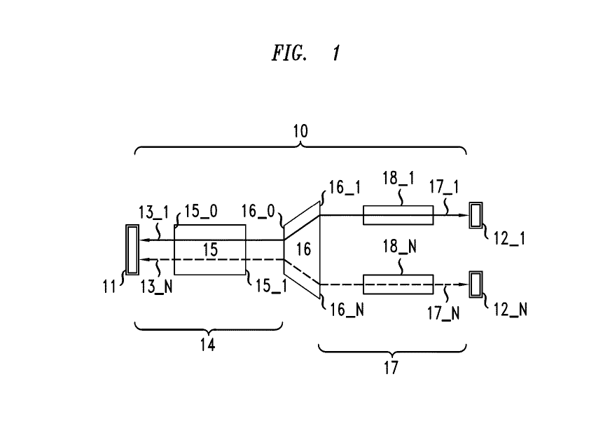

FIG. 1 shows an embodiment of a multi-wavelength laser 10 comprising reflectors 11, and 12_1-12_N, where N represents the number of different wavelengths at which the laser is able to emit light. The end reflector 11 forms N optical cavities 13_1-13_N respectively with the end reflectors 12_1-12_N. A common portion of cavities 13_1-13_N, represented by 14, are shared by all optical cavities. This common portion of the optical cavities includes an optical filter 15 having two optical ports 15_0 and 15_1. Port 15_0 is optically coupled to and faces the end mirror 11, and port 15_1 is optically coupled to and faces the input port 16_0 of an optical wavelength demultiplexer 16. The demultiplexer 16 has N output ports 16_1-16_N and thus, branches the common portion of the optical cavities 14 encompassing 13_1-13_N, into separate paths 17_1-17_N which respectively terminate at the end reflectors 12_1-12_N. A plurality of optical amplifiers 18_1 through 18_N are each inserted into the separate optical paths 17_1-17_N.

Each optical amplifier of 18_1-18_N can be based on any type of optical amplifying medium known in the art and may be pumped either electrically or optically. A particular example is an electrically pumped Semiconductor Optical Amplifier (SOA). It is not necessary that all optical amplifiers are of the same type. Each amplifier may have its own gain spectrum encompassing at least one of the desired output wavelengths. The end reflectors 12_1-12_N may be separate elements or may be part of the optical amplifiers 18_1-18_N. For example, the end reflectors 12_1-12_N may respectively be formed by the facets of edge emitting semiconductor amplifiers 18_1-18_N. In some embodiments, the end reflectors 12_1-12_N may be different portions of a single reflector. The end reflectors 11 and 12_1-12_N may be flat or curved, dielectric or metallic reflecting surfaces, fully or partially reflecting surfaces, or known planar loop reflectors, as appropriate to form an end of a laser cavity.

It is understood by those skilled in the art that even though the element 16 is referred to as optical demultiplexer throughout this disclosure, the element 16 serves as a wavelength demultiplexer in one direction but as a wavelength multiplexer in the other direction. The element 16 combines the functions of spatial multiplexing/demultiplexing and spectral filtering. Each output of 16_1-16_N has its own optical pass bands, which limits the wavelength that the corresponding optical amplifier can lase. Typically, but not necessarily, the pass bands of one of the outputs 16_1-16_N will not overlap the pass bands of other outputs of 16 such that no two optical amplifiers will lase at the same wavelength. Preferably for each output, only one pass band falls within the gain spectrum of the corresponding optical amplifier such that the competition between lasing at various bands within the gain spectrum of one optical amplifier is avoided. But, this is not necessary. In some embodiment, multiple pass bands of an output of 16 fall within the gain spectrum of the amplifier corresponding to the output, but optical feedback of only one pass band is at or above the lasing threshold. Again preferably but not necessarily, the pass bands of output 16_1-16_N are relatively broad compared to the tolerance of ITU grid such that the design criteria of the multiplexer is relatively relaxed. Broader pass bands also help maintain overlap between the pass bands and wavelengths of ITU grid even in the presence of unpredicted shifts of the pass bands due to, for example, thermal instability in the demultiplexer. The demultiplexer may further optionally include tuning elements that are used to shift the pass bands of one or more outputs for the purpose of countering effects from thermal shifts or fabrication errors. For example, such tuning may be implemented thermally by varying the temperature and thus, the optical refractive index of the material of the demultiplexer 16.

The optical demultiplexer 16 can be of any structure known in the art for accomplishing the functions of optical multiplexing/demultiplexing and filtering. The optical demultiplexer 16 can include an optical grating structure, e.g., an Arrayed Waveguide Grating (AWG), a bulk optical grating, or a fiber optical grating. As will be described later in this disclosure, the optical demultiplexer 160 may also be implemented using optical resonator structures.

The optical filter 15 has multiple pass bands corresponding to desired lasing wavelengths. In the context of telecommunications involving DWDM, the desired wavelengths may be the ones specified in an ITU grid with regular frequency spacing of, for example, 200 giga-Hertz (GHz), 150 GHz, 100 GHz, 50 GHz, 25 GHz, or 12.5 GHz. For these particular desired wavelengths, the pass bands of the optical filter 15 are preferably regularly spaced with a periodic frequency spacing matching that of the ITU grid. This regular frequency spacing corresponds to the FSR of the optical filter, which for example, may be implemented as a Fabre-Perot filter or an optical ring resonator. The optical filter may optionally comprise a tuning element, which is able to shift all of its optical pass bands simultaneously without significantly affecting the frequency spacing between the optical pass bands. For example, one can shift the pass bands of an optical ring resonator by tuning the refractive index of the underlying material without substantially modifying the FSR of the optical ring resonator.

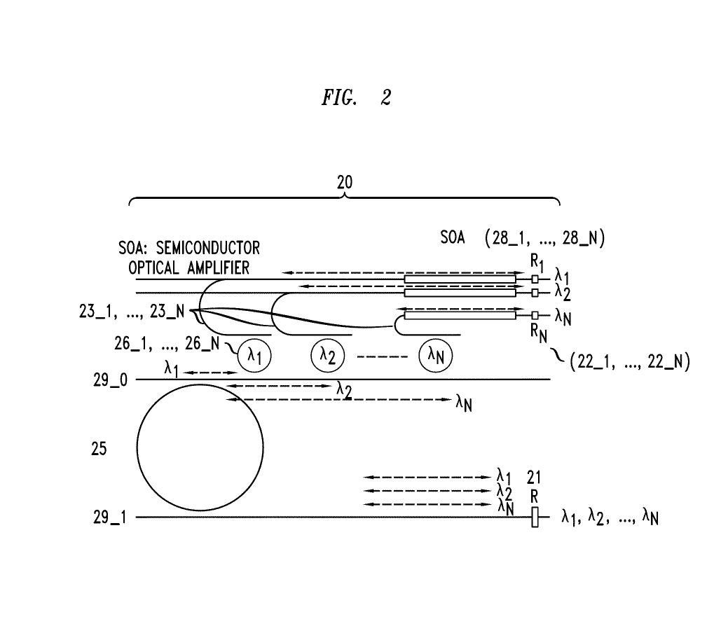

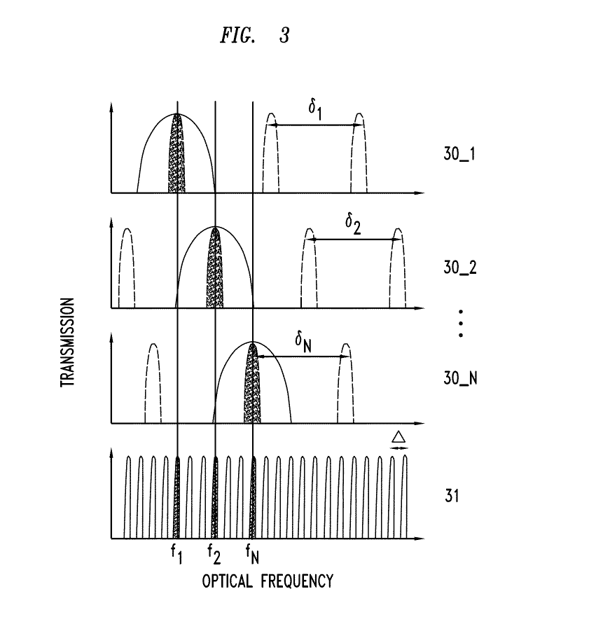

Thus, the combination of the optical amplifiers, the demultiplexer and the common optical filter in the above embodiment may limit the laser to lase at the desired wavelengths. The advantages and principles of operation of such multi-wavelength lasers can be appreciated by those skilled in the art from FIG. 2 and FIG. 3 and related parts of this description.

The multi-wavelength laser 20 shown in FIG. 2 is a specific embodiment of the laser 10 of FIG. 1. The optical amplifiers 28_1-28_N are SOAs and are each optically coupled to a corresponding one of a plurality of end reflectors 22_1 through 22_N and to one of N separate waveguides 23_1-23_N. Each of waveguides 23_1-23_N is optically coupled to a corresponding one of N of optical ring resonators 26_1-26_N, which are further optically coupled to a common optical waveguide 29_0. The optical ring resonators 26_1-26_N function as an optical wavelength demultiplexer. The common waveguide 29_0 is further optically coupled to another optical ring resonator 25, which functions as an optical filter with periodic pass bands. The optical ring resonator 25 is further optically coupled to another waveguide 29_1 that is terminated by an optical reflector 21.

The operation of apparatus 20 of FIG. 2 can be understood from FIG. 3, which illustrates optical transmission bands of various optical elements of apparatus 20 as a function of optical frequency. The spectral response characteristics of the SOAs (elements 28_1-28_N), the optical demultiplexer (ring resonators 26_1-26_N) and the optical filter (optical ring resonator 25) collectively enable laser emission at a set of N desired wavelengths, corresponding to the optical frequencies f₁ though f_{N} in FIG. 3. These frequencies may be, e.g., frequencies in the ITU grid. Each of the N optical amplifiers has an optical gain spectrum illustrated by a corresponding one of the N solid curves in 30_1-30_N. These spectra represent the possible bands of frequencies at which apparatus 200 can lase. The possible lasing frequency bands of apparatus 20 are further limited by the pass bands of optical ring resonators 26_1 to 26_N, which are respectively shown by the dashed curves in 30_1 to 30_N. Each of these optical ring resonators 26_1-26_N supports a series of pass bands, which are regularly spaced in optical frequency with FSRs δ₁-δ_{N}. The optical ring resonators 26_1-26_N are preferably but not necessarily designed such that δ_{N} is larger than the corresponding gain bandwidth of the SOA. In such a manner, only one pass band of each ring resonator falls within the gain spectrum of the corresponding SOA and, as a consequence, competition between lasing at various bands within the gain spectrum of one optical amplifier is avoided. These pass bands are represented by the shaded curves in 30_1 through 30_N and each covers one of desired wavelengths corresponding to f₁ though f_{N}.

Based on the present disclosure, those skilled in the art will appreciate that the N lasing frequencies of apparatus 20 are typically desirably within small tolerance ranges around each of the N frequencies f₁-f_{N}, to be compatible with, for example, the ITU grid specifications. In the absence optical filter 25, the output lasing wavelengths are defined by the shaded pass bands of 30_1 through 30_N. One way to satisfy such a tolerance requirement is to design the N optical ring resonators 26_1-26N with high Quality factors (Q) such that the widths of their pass bands are within the desired tolerances and the center frequencies of the pass bands precisely align with the N frequencies f₁-f_{N}. However, such arrangements are complex, because each optical ring resonator 26_1-26_N would need to be precisely fabricated and thermally stabilized to maintain alignment between its lasing pass band and one of frequencies f₁-f_{N}. Alternatively, to avoid a need to precisely tune every optical ring resonator 26_1-26_N, the optical ring resonators 26_1-26_N can be fabricated to have relatively broad pass bands such that there is overlap between the pass bands and the desired wavelengths even in the presence of fabrication imprecisions and thermal instability. But, a possible drawback of this second alternative is that each of the N optical amplifiers may lase anywhere within the broad pass bands illustrated by the shaded curve of 30_1-30_N of FIG. 3 and consequently the lasing frequencies may not be stable and may fall outside the tolerances for the N frequencies f₁-f_{N} required by ITU grid specifications.

Such a drawback may be eliminated by the inclusion of the common optical ring resonator 25 of FIG. 2, i.e., a periodic optical filter. The common optical ring resonator 25 can be fabricated to have sharp pass bands (high Q) and can have a precise frequency spacing between the pass bands due to the resonator's periodicity. Such a spacing, which is the resonator's FSR, is labeled as A in FIG. 3. Preferably, the FSR matches the spacing between the N desired optical frequencies f₁-f_{N}. But this is not necessary. For example, the spacing between the N desired optical frequencies f₁-f_{N} may be any integer multiples of A, as illustrated 31 of FIG. 3. The FSR of the ring resonator may be rather insensitive to thermal instabilities. The center wavelengths of the pass bands of such an optical resonator, however, are typically more susceptible to fabrication imprecision and thermal instability. But, such a defect can be solved by tuning the optical filter 25 and stabilizing the lasing wavelengths onto the desired grid. Such tuning can be achieved, for example, by a phase shifter that adjusts the refractive index of the common optical ring resonator 25. Such a phase shifter can be realized, for example, based on thermal effects. Such tuning may have an insignificant impact on the precisely designed FSR Δ. In this way, a single tuning mechanism is typically sufficient to fix the shaded sharp bands in 31 at the N frequencies f₁-f_{N}. It is understood that thermal tuning is just one example of a suitable mechanism for optical tuning. Phase shifters based on any other mechanisms known in the art can be used for tuning the common optical ring resonator 25.

Thus, the SOA, the optical demultiplexer, and the optical filter of the apparatus 20 function together to produce laser emission only at the N frequencies f₁-f_{N}, and can stabilize these N frequencies within a preset maximum drift. The apparatus 20 typically and advantageously only requires the precise tuning and stabilization of a single optical element, i.e., the common optical ring resonator 25. The output power of each optical frequency may be conveniently controlled by the degree of pumping of each SOA.

Laser emissions of frequencies f₁-f_{N} may be output separately from reflectors 22_1-22_N, each functions as an output coupler for the corresponding emission. Alternatively for some applications, all laser emissions may be output as one beam from the reflector 21.

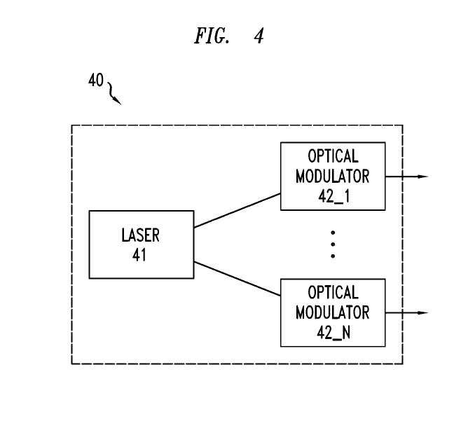

FIG. 4 illustrates one embodiment of an optical data transmitter 40 that includes a multi-wavelength laser 41 based on the embodiments of FIG. 1-2. The laser 41 output is configured to be spatially separate N optical carriers with wavelength λ₁-λ_{N}. These optical carriers are each directed to a corresponding one of the optical modulators 42_1-42_N. Each of the optical modulators is configured to modulate a digital data stream onto one of the optical carriers. Each modulated optical carrier represents one distinct optical channel.

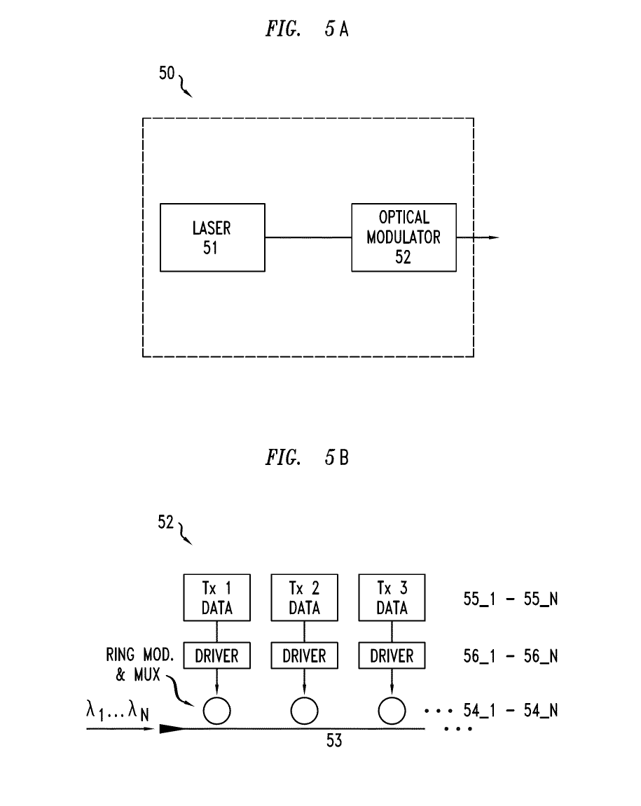

FIG. 5(a) illustrates another embodiment of an optical transmitter 50 that includes a multi-wavelength laser 51 based on the embodiments of FIG. 1-2. The laser 51 outputs laser light with wavelength λ₁-λ_{N} as one beam. Light of each wavelength represents one optical carrier. The single beam containing all wavelengths is directed to optical modulator 52 where separate digital streams are individually modulated onto each optical carrier. FIG. 5(b) illustrates an exemplary embodiment of optical modulator 51 that can be used in the optical transmitter 50. In FIG. 5(b), optical carriers having wavelength λ₁-λ_{N} are optically coupled into an waveguide 53, which in turn is coupled to ring resonators 54_1-54_N. The ring resonators 54_1-54_N are each configured to optically couple to one of the N optical carriers into the ring resonator and modulate one of the digital data streams 55_1-55_N by one of the drivers 56_1-56_N onto the coupled carrier.

For the optical transmitter 40 and 50 illustrated in FIG. 4 and FIG. 5(a)-(b), the digital data streams can be modulated onto the light carriers in any modulation format known in the art. For example, the modulation format can be on-off keying, binary phase shift keying, quadrature phase shift keying, or quadrature amplitude modulation. The wavelengths of the light carriers may be stabilized by tuning a single optical element within the multi-wavelength laser 41 and 51.

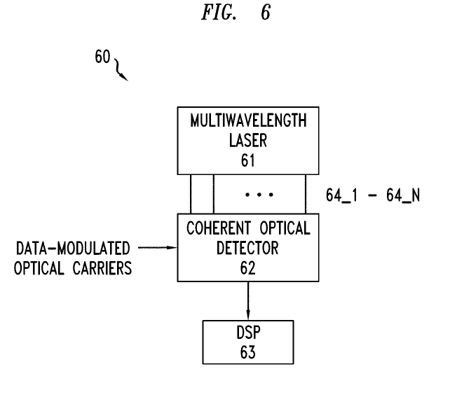

FIG. 6 illustrates a coherent optical data receiver 60 that includes a multi-wavelength laser 61 based on the embodiments of FIG. 1-2 and a Coherent Optical Detector (COD) 62, and a Digital Signal Processor (DSP) 63. In the coherent optical data receiver 60, the multi-wavelength laser 61 functions as local optical oscillators whose light is optically mixed with the received data-modulated optical carriers in the COD. Such optical mixing enables the detection of modulations in the received data-modulated optical carriers. The output of the COD is directed to the DSP 63 for recovering the data streams modulated onto the data-modulated optical carriers.

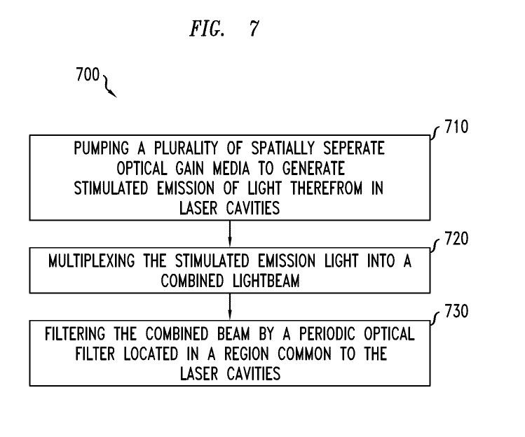

FIG. 7 illustrates a method 700 for producing laser light of multiple wavelengths, e.g., in the lasers 10, 20 of FIGS. 1 and 2. The method 700 includes pumping a plurality of spatially separate optical gain media to generate stimulated emission of light therefrom in laser cavities (step 710); multiplexing the stimulated emission light into a combined light beam (step 720); and filtering the combined beam by a periodic optical filter located in a region common to the laser cavities (step 730).

While the particular inventions have been described with reference to illustrative embodiments, this description is not meant to be limiting. Various modifications of the illustrative embodiments and additional embodiments of the inventions will be apparent to one of ordinary skill in the art from this description. Those skilled in the art will readily recognize that these and various other modifications can be made to the exemplary embodiments, illustrated and described herein, without departing from the spirit and scope of the present invention. It is therefore contemplated that the appended claims will cover any such modifications and alternate embodiments.

I claim:

1. An apparatus comprising a multi-wavelength laser, the laser comprising:
a plurality of optical cavities, each laser optical cavity having a corresponding optical amplifier;
a periodic optical filter being a common segment of the laser optical cavities; and
an optical wavelength demultiplexer including an optical input and a plurality of optical outputs;
wherein each of the laser optical cavities includes an optical path segment between a corresponding optical output of the optical wavelength demultiplexer and the optical input of the optical wavelength demultiplexer.

2. The apparatus of claim 1, wherein pass bands of the optical wavelength demultiplexer are wider than the pass bands of the periodic optical filter.

3. The apparatus of claim 1, wherein the periodic optical filter has a free spectral range approximately matches the frequency spacing of an ITU grid.

4. The apparatus of claim 1, wherein the periodic optical filter include a tunable optical phase shifter enabling frequency-shifting of the pass bands of the optical filter as a group.

5. The apparatus of claim 1, wherein the optical wavelength demultiplexer comprises a plurality of optical resonators, an input optical waveguide optically coupled to the optical resonators, and a plurality of output optical waveguides, each output optical waveguide of the optical waveguide demultiplexer being optically coupled to a corresponding one of the optical resonators.

6. The apparatus of claim 1, wherein the laser output light of multiple wavelengths as a single beam.

7. The apparatus of claim 1, wherein the laser output light of each wavelength as a separate beam.

8. The apparatus of claim 1, further comprising an optical data transmitter including the laser and an external optical data modulator, the external optical modulator being configured to modulate light emitted by the laser.

9. The apparatus of claim 1, further comprising a coherent optical data receiver comprising the laser and being configured to determine a digital data stream carried by a phase-modulated optical carrier, in part, by optically mixing light of the phase-modulated optical carrier with light emitted by the laser.

10. A method of generating a laser output of multiple wavelength, comprising:
producing laser light in a sequence of separate frequency bands by pumping a plurality of spatially separate optical gain media to generate stimulated emission of light therefrom in laser cavities;
wherein the producing includes multiplexing the stimulated emission light into a combined light beam, and filtering the combined beam by a periodic optical filter located in a region common to the laser cavities.

11. The method of claim 8, further comprising mixing a portion of light emitted by the laser with a received phase-modulated optical carrier to perform coherent detection of the phase modulated optical carrier in a coherent optical receiver.

12. method of claim 8, further comprising modulating light emitted by the laser to produce, in an optical transmitter, a modulated optical carrier.
